(19) United States
(12) Patent Application Publication
(10) Pub. No.: US 2003/0108678 A1
(43) Pub. Date: Jun. 12, 2003

(54) Process and device for spraying a moving fibrous material web

(75) Inventor: Frank Wegehaupt, Bohmenkirch (DE)

Correspondence Address: GREENBLUM & BERNSTEIN, P.L.C., 1950 ROLAND CLARKE PLACE, RESTON, VA, 20191, US

(73) Assignee: VOITH PAPER PATENT GMBH, Heidenheim (DE)

(21) Appl. No.: 10/261,493

(22) Filed: Oct. 2, 2002

(30) Foreign Application Priority Data
Dec. 11, 2001 (DE) 101 60 725.3

(51) Int. Cl. B05D 1/02

(52) U.S. Cl. 427/421; 118/300

(57) ABSTRACT

Process and device for spraying a moving fibrous material web with at least one nozzle. The process includes feeding a spray medium volume flow of the at least one nozzle via at least one valve and damping or weakening pulsations occurring in the volume flow of the spray medium. The device includes at least one nozzle, at least one valve arranged to feed a spray medium volume flow to said at least one nozzle, and a damping element arranged to damp or weaken pulsations occurring in the volume flow of the spray medium.

### CROSS-REFERENCE TO RELATED APPLICATIONS

The present application claims priority under 35 U.S.C. §119 of German Patent Application No. 101 60 725.3, filed on Dec. 11, 2001, the disclosure of which is expressly incorporated by reference herein in its entirety

### BACKGROUND OF THE INVENTION

1. Field of the Invention

The invention relates to a process and device for spraying a moving fibrous material web, in particular a paper or cardboard web, with at least one nozzle, in which a preferably adjustable volume flow of the relevant spray medium is fed to the nozzle.

2. Discussion of Background Information

In the manufacture, refining and processing of fibrous material webs, sprayers are used to specifically influence certain web properties. These properties can be, e.g., the moisture content, the surface moisture, the surface coating and/or the like. Alternatively or additionally, an injection with additives is also conceivable. In applications where a variable volume flow is sprayed (see, e.g., the moisture cross profiling with nozzle moisteners in paper manufacturing), the two following control concepts are currently used:

A. Parallel connection of the valves (binary volume flow control) With such a parallel connection of the valves with binary volume flow control, several valves with different throughput amounts are connected parallel to one another as a valve block. Each valve recognizes only the state of open or closed. Additively different total volume flows can be produced by opening individual valves with different volume flow.

This control concept has the disadvantage that only a graduated volume flow characteristic curve can be produced by the addition. Another disadvantage is the large number of individual valves per nozzle and the resulting large amount of space required by and the high cost of the valve block.

B. Serial arrangement of the nozzles (binary volume flow control) With such a serial arrangement, several nozzles with different throughput amounts when spraying in the web travel direction are arranged in succession. Each nozzle is controlled by a valve that recognizes only the state of open or closed. Additively different total volume flows can be produced by the combination of individual opened nozzles.

This control concept has the disadvantage that only a graduated volume flow characteristic curve can be produced by the addition. Another disadvantage is the large number of individual valves and nozzles and the resulting high cost of the total spray unit.

A pulsed dampening spray system is known, e.g., from German Patent Application No. DE 689 24 433 T2, which is used for feeding dampening fluid to a roll of a printing press.

### SUMMARY OF THE INVENTION

The present invention provides a process and a device of the type mentioned at the outset, with which the disadvantages listed above are eliminated.

With regard to the process, the instant invention provides that the spray medium volume flow is fed to the nozzle via at least one solenoid valve in the form of a pulsation valve or a discontinuously activated proportional valve. In this manner, pulsations occurring in the volume flow of the spray medium are preferably damped or weakened. The volume flow fed to the nozzle is thereby preferably adjusted via the valve. In the case of proportional valves, they should be controlled with short switch transfers between the on/off switching values according to the principle of pulse width modulation.

The valves are preferably used in paper and cardboard machines, in particular in nozzle moisteners, coating aggregates, starch sprayers, profiling installations, etc. In principle, a use is possible for the volume flow control of liquids in nozzles for spraying fibrous moving webs, in particular in sprayers in paper and cardboard machines, such as in nozzle moisteners, coating aggregates, starch sprayers, profiling installations, etc.

An anchor valve, and in particular a plate anchor valve is preferably used as a pulsation valve and a needle valve is preferably used as a proportional valve.

Pulsating valves per se are already described in the printed publications DE 41 396 71 C2 and DE 44 194 46 C2, the disclosures of which are expressly incorporated by reference herein in their entireties.

In a preferred practical embodiment, pulsations occurring in the volume flow of the spray medium are damped or weakened by at least one pulsation damper located upstream of the nozzle and/or by the use of a nozzle with a correspondingly large spray width measured in the web travel direction and/or by the use of a flexible feed line to the nozzle.

Pulsation dampers or pulse dampers use the compressibility of gases to compensate for fluctuations in pressure. The arrangement of the feed line and the output line in a closed gas volume that is clearly larger in comparison with the cross section of the line renders possible the inflow of the liquid as long as both cross sections (input and output) are immersed in the liquid. The remaining gas volume is enclosed and is compressed according to the applied pressure. The gas pilot pressure is adjusted to the operating pressure. Quickly subsiding fluctuations in pressure (pulsations) change the volume of the enclosed gas (predominantly air). The energy-converting compression and expansion of the gas cushion stabilize the occurring pulsations.

However, the damping can also be carried out by a membrane accumulator. The membrane accumulator has two areas divided by a flexible membrane, whereby one area is filled with a gas, e.g., air or nitrogen, and the other area is filled with the spray medium.

With the flexible, soft feed line to the nozzle which can be used in particular in combination with a valve, the fact is exploited that the elasticity of such a flexible nozzle feed line has a damping effect. The flexible nozzle feed line can be formed by, e.g., a polyethylene, polyurethane or a polyamide hose. It can have a length that is, e.g., longer than about 3 m and preferably longer than about 5 m. A corresponding arrangement is preferably used in paper and cardboard machines, in particular in nozzle moisteners, coating aggregates, starch sprayers, profiling installations, etc.

It is advantageous for a nozzle to be used whose spray width measured in web travel direction is at least about 30% and preferably at least about 50% of the spray width measured in web cross direction.

In certain cases, it is advantageous if a flat spray nozzle is used as a nozzle. An elliptical flat spray nozzle, for instance, can also be used.

Such flat spray nozzles can be used, e.g., in combination with the mentioned pulsation dampers and/or flexible nozzle feed lines which ensure an adequate damping of the pulsations. A property of flat spray nozzles is that all sprays strike the fibrous material web at approximately the same angle in the web travel direction. The efficiency of the moistening is dependent on this angle. This has the advantage that the optimum angle can be set for a maximum moistening effectiveness.

In a preferred practical embodiment, a flat spray nozzle is used as a nozzle, which sprays against the web travel direction at a pitch angle to the fibrous material web, which can be, e.g., less than approx. 80° and preferably less than approx. 70°. Thus, the efficiency of the moistening is increased or a misting is reduced accordingly. A corresponding flat spray nozzle can be advantageously used at web speeds above in particular about 1200 m/min and preferably above about 1500 m/min. A corresponding arrangement is preferably used in paper and cardboard machines, in particular in nozzle moisteners, coating aggregates, starch sprayers, profiling installations, etc.

In certain cases, it can also be advantageous for a full cone nozzle to be used as a nozzle.

The volume flow fed via such a valve is advantageously adjusted by a pulse width modulation. The valve is thereby preferably activated with constant clock frequency, such that the clock frequency should be below about 120 Hz, preferably below about 70 Hz and in particular below about 30 Hz.

The disclosed process is advantageously used in paper or cardboard machines and in particular in nozzle moisteners, coating aggregates, starch sprayers, profiling installations and/or the like.

Moreover, the device according to the present invention provides that the spray medium volume flow is fed to the nozzle via at least one valve in the form of a pulsation or proportional valve. In this way, the device is structured and arranged to damp or weaken pulsations occurring in the volume flow of the spray medium.

On the basis of the process and the device according to the invention, pulsation valves, e.g., anchor valves and in particular plate anchor valves, such as pulsation valves with a plate anchor, or proportional valves, e.g., needle valves, can be used in paper and cardboard machines. Particularly advantageous uses of the process can be made in nozzle moisteners, coating aggregates, starch sprayers, profiling installations and/or the like. The respective valves can be provided in particular for the volume flow control of the relevant spray medium. The following advantages of such valves, in particular, can thus also be used:

Continuous control of a mean volume flow of 0% to 100%;

Suitable for smaller volume flows and liquid pressures; and

Due to the large control area, only one valve and only one nozzle per spray position in machine cross direction necessary.

Due to the features of the instant invention, it is ruled out that the pulsations produced by such valves are transferred to the spray liquid.

The respective pulsation dampers (or elastic feed lines) can be used in particular in lines for liquids or suspensions in paper and cardboard machines. For instance, at least one pulsation damper can be used in the relevant line between a nozzle and a valve of any construction type, preferably a pulsation valve. The pulsation dampers can be used, e.g., in installations for spraying moving fibrous material webs, in particular in sprayers in paper and cardboard machines, and in particular in nozzle moisteners, coating aggregates, starch sprayers, profiling installations and/or the like. The advantages of these pulsation dampers include, e.g.:

Pulsations in the spray liquid, such as those produced in particular by valves, are damped; and

Fluctuations in the amount of spray on the moving fibrous material web are accordingly reduced.

Pulsation valves, e.g., particular anchor valves and preferably plate anchor valves, or proportional valves, e.g., needle valves, can be combined for a use in paper and cardboard machines with pulsation dampers and/or flexible feed lines. A unit or combination of a valve and a pulsation damper and/or an elastic nozzle feed line can thus be formed.

Pulsation valves, e.g., anchor valves and preferably plate anchor valves, or proportional valves, e.g., needle valves, can also be combined with the respective liquid spray nozzle, in addition to pulsation dampers and/or flexible feed lines. Such combinations can be used, e.g., in installations for spraying moving fibrous material webs, in particular in sprayers in paper and cardboard machines and in particular in nozzle moisteners, coating aggregates, starch sprayers, profiling installations and/or the like. A respective unit of a valve, a pulsation damper and/or a flexible feed line and a nozzle can thus be formed.

One advantage of such a unit or combination including a pulsation damper and/or a flexible feed line, a valve and a nozzle is that, due to the pulsation damping, a pulsing valve can be used for spraying moving webs.

Pulsation valves, e.g., anchor valves and preferably plate anchor valves, or proportional valves, e.g., needle valves for spraying moving fibrous material webs for a use in sprayers in paper and cardboard machines, such as in nozzle moisteners, coating aggregates, starch sprayers, profiling installations and/or the like, can also be used, e.g., in combination with nozzles having a spray width in the web travel direction that is large, i.e., more than about 30% of the spray width in the web cross direction. In this regard, elliptical flat spray nozzles or full cone nozzles can be used. Thus, a respective unit can also include a pulsating valve and a nozzle with a large spray width.

The advantages of a use of such nozzles in connection with pulsating valves include, e.g., that a pulsation in the volume flow is weakened in the spray pattern due to the large spray width in the web travel direction. This can be attributed to the fact that the dampening of a point on the moving web is made by the large spray width over a longer period of time. Fluctuations in the volume flow can thus be compensated for during this period at this point.

Pulsating valves, e.g., anchor valves and preferably plate anchor valves, or correspondingly activated proportional valves can also be used in combination with at least one pulsation damper and/or a flexible feed line and in combination with nozzles having a large spray width in the web travel direction, e.g., larger than about 30% and preferably larger than about 50% of the spray width in the web cross direction. In this manner, elliptical flat spray nozzles or full cone nozzles can be used to spray moving fibrous material webs. In particular, an advantageous use in sprayers in paper and cardboard machines, such as in nozzle moisteners, coating aggregates, starch sprayers, profiling installations and/or the like is attainable. A respective pulsating valve can thus also be used in particular in combination with a pulsation damper and a nozzle with a large spray width.

Due to the large spray width of the nozzle in the web travel direction and the use of at least one damper, fluctuations in the moisture are largely eliminated by spraying on the moving web, such that a use for quickly moving webs is also possible.

The present invention also provides a process and a device for volume flow control with at least one valve for liquid media, which control the volume flow at a nozzle or a group of nozzles and can be used for spraying moving fibrous material webs in particular in sprayers in paper and cardboard machines, such that a use in nozzle moisteners, coating aggregates, starch sprayers, profiling installations and/or the like is possible.

Valves produce per se a pulsating volume flow which can be transferred to the spray pattern during the spraying of moving webs. The amount of spray applied would thus vary in the travel direction of the web according to the pulsation. The extent of the variation of the amount of spray thus depends on the following factors: frequency of the pulsation, web speed, spray width in the web travel direction, number of nozzles in the web travel direction and damping of the pulsation. Through the solution according to the invention, undesirable fluctuations in the volume flow in liquid lines, caused, e.g., by natural vibrations of machine components, such as in particular of such valves, are now damped in paper and cardboard machines.

A continuous, i.e., constant and not cascade-like, volume flow characteristic curve is obtained over the entire control range with the use of one or more valves. In contrast to the state of the art, any volume flows can thus be adjusted, which, e.g., permits a more precise reply function in moisture profiling with nozzle moisteners.

A spray that is low in pulsations is possible due to the damper system according to the invention. This is achieved, e.g., by reducing the liquid fluctuations after the valve by in particular at least about 50%, in particular at least about 80% and in particular at least about 90%, directly before the nozzle. Pulsations in the spray liquid which are caused by vibrating machine parts, e.g., a pump or a pulsating valve, thus are damped, which improves the uniformity of the spray pattern in the web travel direction.

An even spraying of a moving fibrous material web, such as in particular a paper web, is possible, the speed of which (v) can be higher than, e.g., about 500 m/min, in particular higher than about 1000 m/min and preferably higher than about 1500 m/min. With increasing web speed, fluctuations in the volume flow with high frequencies can also be recognized in the spray pattern.

Smaller structural dimensions for the control unit can be achieved compared with the prior art by using fewer valves per nozzle, in particular with only one valve per nozzle, in particular in sprayers in paper and cardboard machines, which can make it possible if necessary to integrate the valve directly into the spray bar.

Because of the smaller number of valves and/or nozzles compared with the prior art, in particular with only one valve per nozzle or only one nozzle per spraying position in web cross direction, and/or more cost-effective valves, more low-maintenance and more cost-effective sprayers can be produced, particularly in sprayers in paper and cardboard machines.

As a spray medium, e.g., liquids, in particular water, additives such as polyethylene glycol, polyvinyl alcohol, tensides, starch, inoculants, (coating) paints and varnishes are conceivable.

The volume flows per nozzle and/or valve can be, e.g., in a range up to a maximum of about 30 l/min, in particular up to a maximum of about 0.70 l/min and preferably up to a maximum of about 0.20 l/min.

The device according to the invention is also remarkable for its relatively high durability. A use in almost continuous operation with over 70% length of operation, in particular with over 90% length of operation with a service life of at least three years, in particular at least 5 years, is thus conceivable.

The invention can also be used in particular at pressures of less than about 20 bar, in particular less than about 2 bar, and preferably less than about 1 bar.

Different nozzle types can in particular also be used. These include in particular single-component nozzles, two-component nozzles (liquid-gas, liquid-liquid), mixing inside or outside, different spray forms, in particular flat spray nozzles and in particular full cone nozzles.

Volume flows in particular in a ratio of less than about 1:5, in particular less than about 1:10, and in particular less than about 1:15, are conceivable.

The present invention is directed to a process for spraying a moving fibrous material web with at least one nozzle. The process includes feeding a spray medium volume flow of the at least one nozzle via at least one valve and damping or weakening pulsations occurring in the volume flow of the spray medium.

According to a feature of the instant invention, the fibrous material web can include one of a paper or cardboard web.

In accordance with another feature of the invention, the at least one nozzle can feed an adjustable volume flow of the spray medium. The at least one valve may include one of a pulsation valve or a discontinuously activated proportional valve. The at least one valve can include a solenoid valve. Further, the pulse valve can include one of an anchor valve or a plate anchor valve, and the proportional valve comprises a pulsation valve.

The process may further include adjusting the spray medium volume flow fed to the at least one nozzle via the at least one valve.

According to still another feature of the invention, the damping or weakening of pulsations may include at least one of: (A) positioning at least one pulsation damper upstream of the at least one nozzle relative to a volume flow direction; (B) spraying a large spray width measured in a web travel direction via the at least one nozzle; and (C) feeding the spray medium to the at least one nozzle through a flexible feed line. The at least one nozzle can have a large spray width measured in the web travel direction comprises with a spray width measured in the web travel direction which is at least about 30% of the spray width measured in the web cross direction. Further, the spray width measured in the web travel direction which can be at least about 50% of the spray width measured in the web cross direction.

According to a further feature of the present invention, the at least one nozzle can include an elliptical flat spray nozzle.

The at least one nozzle can include a flat spray nozzle arranged to spray the spray medium in a direction opposite a web travel direction, and at a pitch angle less than approx. 80°. The pitch angle can be less than approx. 70°. Further, the web may be driven at a web speed greater than about 1200 m/min, and preferably, the web speed is greater than about 1500 m/min.

According to still another feature of the present invention, the at least one nozzle may include a full cone nozzle.

Further, the spray medium volume flow fed through the nozzle can be adjusted by a pulse width modulation. The at least one valve may be activated with a constant clock frequency. The clock frequency can be less than about 120 Hz, may be less than about 70 Hz, and can preferably be less than about 30 Hz.

The web can be produced in one of a paper or a cardboard machine, and the process may occurs in at least one of nozzle moisteners, coating aggregates, additive sprayers, and profiling installations of the paper or cardboard machine.

The present invention is directed to a device for spraying a moving fibrous material web. The device includes at least one nozzle, at least one valve arranged to feed a spray medium volume flow to the at least one nozzle, and a damping element arranged to damp or weaken pulsations occurring in the volume flow of the spray medium.

According to a feature of the invention, the at least one valve can be structured and arranged to adjust the volume flow of the spray medium to the at least one nozzle. The at least one valve may include one of a pulsation valve or a discontinuously activated proportional valve. The at least one valve can include a solenoid valve arranged to adjust the volume flow fed to the at least one nozzle. Further, the pulsation valve may include an anchor valve and the proportional valve may include a needle valve. The anchor valve can include a plate anchor valve.

The damping element can include at least one of: (A) at least one pulsation damper located upstream of the at least one nozzle; (B) the at least one nozzle, which is structured and arranged to produce a large spray width measured in a web travel direction; and (C) a flexible feed line coupled to the nozzle. The at least one nozzle can be structured and arranged to produce a spray width measured in the web travel direction that is at least about 30% of a spray width measured in the web cross direction, and preferably, the at least one nozzle is structured and arranged to produce a spray width measured in the web travel direction that may be at least about 50% of a spray width measured in the web cross direction.

In accordance with another feature of the instant invention, the at least one nozzle can include an elliptical flat spray nozzle.

According to still another feature of the invention, the at least one nozzle may include a flat spray nozzle. The flat spray nozzle can be oriented in a direction opposite a web travel direction, and at a pitch angle of less than approx. 80°. Further, the pitch angle can be less than approx. 70°.

In accordance with a further feature of the invention, the at least one nozzle can include a full cone nozzle.

According to the invention, the at least one valve can adjust the volume flow by a pulse width modulation. The at least one valve can be activated with a constant clock frequency, and the clock frequency can be less than about 90 Hz, preferably, less than about 30 Hz, and most preferably, less than about 10 Hz.

In accordance with still another feature of the present invention, the damping element may include a flexible feed line composed of a polyethylene, polyurethane or polyamide hose. The flexible feed line to the at least one nozzle can have a length longer than about 3 m, and preferably longer than about 5 m.

According to a further feature of the invention, the at least one valve and the damping element can be arranged in a unit.

In accordance with a still further feature of the invention, the at least one valve, the damping element which can include at least one of a pulsation damper and a flexible feed line, and the at least one nozzle may be arranged in a unit.

In accordance with still yet another feature of the present invention, the device can be utilized in combination with one of a paper or a cardboard machine, such that the device can be arranged in at least one of nozzle moisteners, coating aggregates, starch sprayers, and profiling installations of the one paper or cardboard machine.

The present invention is directed to a process for spraying a moving fibrous material web with the device of the instant invention. The process includes feeding an adjustable spray medium volume flow of the at least one nozzle via the at least one valve, which comprises one of a pulsation valve or a discontinuously activated proportional valve, and damping or weakening pulsations occurring in the volume flow of the spray medium.

The present invention is directed to a device for performing the process in accordance with the invention. The device includes at least one nozzle, at least one valve structured and arranged to adjust a volume flow of a spray medium to the at least one nozzle in order to feed the spray medium volume flow to the at least one nozzle, wherein the at least one valve comprises one of a pulsation valve or a discontinuously activated proportional valve, and a damping element arranged to damp or weaken pulsations occurring in the volume flow of the spray medium.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates an exemplary embodiment of a device for spraying a fibrous material web;

FIG. 2 illustrates a diagram explaining the functioning of the valve depicted in FIG. 1;

FIG. 3 illustrates a characteristic curve of a valve providing a continuous volume flow control compared with a characteristic curve of a normally controlled proportional valve;

FIGS. 4A and 4B comparatively illustrate a spray pattern of a full cone nozzle having a large spray width measured in the web travel direction with the spray pattern of a flat spray nozzle; and

FIG. 5 illustrates an exemplary arrangement a flat spray nozzle spraying at a pitch angle against the web travel direction.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

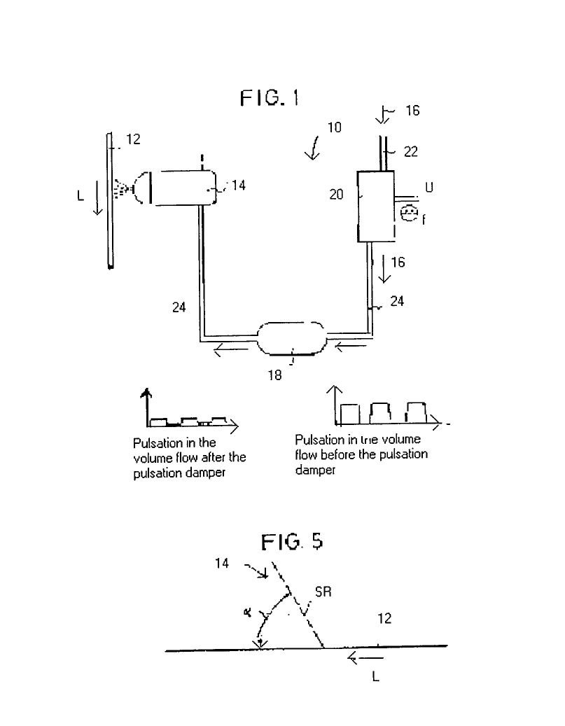

FIG. 1 shows in a diagrammatic partial representation an exemplary embodiment of a device 10 for spraying a moving fibrous material web 12. The fibrous material web 12 can be, e.g., a paper or cardboard web.

Device 10 comprises at least one nozzle 14, to which a preferably adjustable volume flow of relevant spray medium 16 is supplied. At least one pulsation damper 18 is located upstream of nozzle 14 to damp pulsations contained in the volume flow of spray medium 16.

The volume flow of the spray medium 16 is adjusted via a valve 20, which can be, e.g., a pulsation valve, such as an anchor valve and in particular a plate anchor valve, or a proportional valve, such as a needle valve. Valve 20 is activated via a control voltage U with a clock frequency f. In this way, the volume flow can be varied, e.g., by a pulse width modulation. In this case clock frequency f is preferably maintained at a constant level and is approx. 30 Hz.

As can be seen from FIG. 1, spray medium 16 is fed to valve 20 through a line 22. Pulsation damper 18 is arranged in a line 24 connecting valve 20 with the nozzle 14. It is thus located between valve 20 and nozzle 14.

FIG. 1 also illustrates exemplary pulsations of the volume flow before and after pulsation damper 18. A comparison of the two pulsation diagrams shows that the pulsation contained in the volume flow of spray medium 16 is damped by pulsation damper 18.

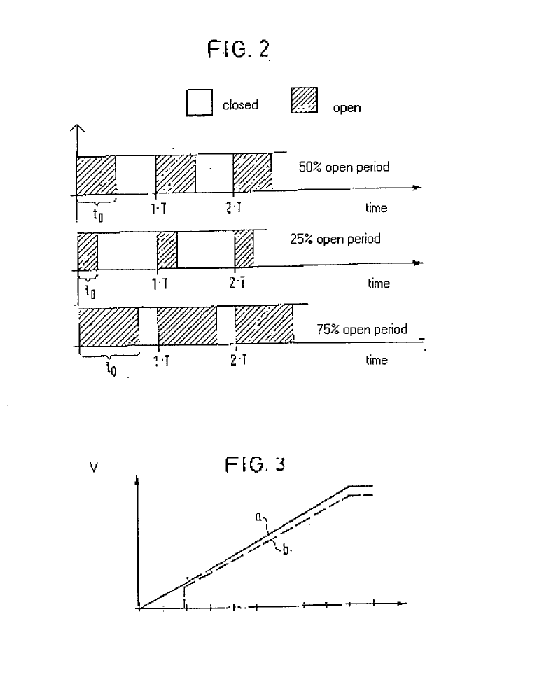

FIG. 2 shows a functional diagram explaining the functioning of valve 20. Valve 20 opens and closes the throughput once during a generally constant interval of duration T, or it remains continuously open or remains continuously closed. The duration of the opening interval to can be varied. A ratio t₀/T determines the open period of valve 20. The longer the open period, the more liquid flows through the valve. Thus, the volume flow of the liquid can be controlled accordingly. The first time diagram results with an open period of 50%, the second with an open period of 25% and the third with an open period of 75%.

FIG. 3 shows an example of a characteristic curve (a) of a valve with continuous volume flow control compared with a corresponding characteristic curve (b) of a conventionally controlled proportional valve.

The device includes a unit or combination of valve 20, pulsation damper 18 and nozzle 14 (as illustrated in FIG. 1) that can be used in devices for spraying moving fibrous material webs 12, such as in sprayers in paper and cardboard machines, in particular in steam moisteners, coating aggregates, starch sprayers, profiling installations and/or the like. Pulsations contained in spray medium 16, as produced in particular by valve 20, are damped by pulsation damper 18.

Thus, fluctuations in the amount of spray on the moving fibrous material web are reduced.

Instead of or in addition to a pulsation damper, e.g., a flexible feed line to the nozzle can also be provided.

Moreover, it is also possible to use, e.g., a pulsing valve 20 in combination with a nozzle with a large spray width or depth measured in web travel direction L. For instance, a unit or combination of a valve and a nozzle with a large spray width measured in the web travel direction or a unit or combination of a valve, a pulsation damper (and/or a flexible feed line) and a nozzle with a large spray width measured in the web travel direction can thereby be provided.

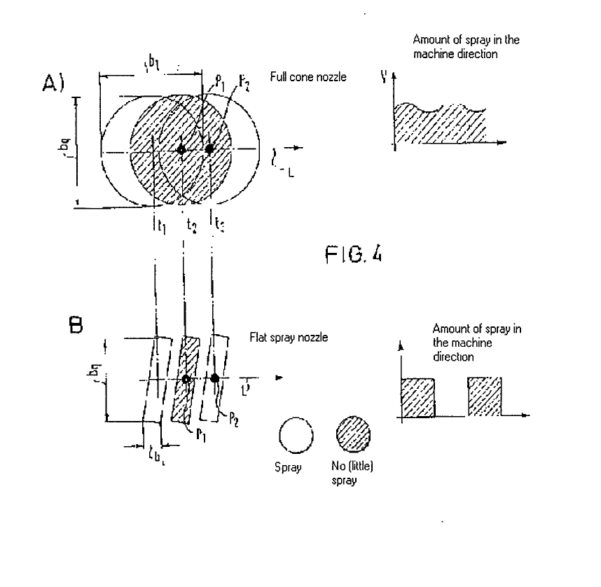

FIG. 4 shows the spray pattern A of nozzle 14 having, e.g., large spray width b, measured in web travel direction L, e.g., a full cone nozzle, compared with a spray pattern B of nozzle 14 having, e.g., flat spray nozzle.

Parts A and B of FIG. 4 show the spray pattern of the respective nozzle at the points in time t₁, t₂ and t₃. The displacement of the respective spray pattern corresponds to the moving web. The cross-hatched area of the respective spray pattern that at this point in time the nozzle was not spraying or spraying only a little. In contrast, the nozzle is spraying in the areas of the respective spray pattern that are not cross-hatched. The time characteristic of the pulsation is thus described.

Spray pattern A results from a full cone nozzle with large spray width bₗ measured in web travel direction L. Points P₁ and P₂ are overlapped by a spray pattern with spraying and a spray pattern without spraying. Despite a pulsation contained in the volume flow of spray medium 16, this leads to a uniform spray pattern at points P₁ and P₂ (see the graphical depiction of the amount of spray (continuous) in FIG. 4A).

Spray pattern B results from a flat spray nozzle with a small spray width bₗ measured in the web travel direction L. Points P₁ and P₂ are overlapped respectively only by a spray pattern with spraying (P₂) or a spray pattern without spraying (P₁). This leads to the pulsation contained in the volume flow of the spray medium being completely transferred to the spray pattern of the web 12 (see the graphical depiction of the amount of spray (intermittent) in FIG. 4B).

Large spray widths b, measured in web travel direction L thus lead to a homogenization of the pulsation contained in the volume flow of the spray medium while the nozzle is spraying, as shown by a comparison of the portions of FIGS. 4A and 4B graphically depicting the amounts of spray over the length of the web.

Instead of a full cone nozzle, e.g., an elliptical flat spray nozzle can be used as a nozzle with a large spray width b, in the web travel direction.

Thus, a pulsation contained in the volume flow can be weakened in the spray pattern by a large spray width bₗ measured in the web travel direction. This can be attributed to the fact that the moistening of a respective point on the moving web is made through the large spray width over a longer period of time. Fluctuations in the volume flow are thus compensated for during this period at the relevant point. Spray width bₗ of the relevant nozzle measured in the web travel direction can be, e.g., more than about 30% of the spray width b_{q} measured in the web cross direction.

As shown by FIG. 5, a flat spray nozzle can be used as nozzle 14, which flat spray nozzle sprays at a pitch angle α to fibrous material web 12 against web travel direction L. FIG. 5 shows the corresponding spray direction, labeled SR. The pitch angle α can be in particular less than approx. 80° and preferably less than approx. 70°.

Both a unit or combination of a valve and a nozzle with a large spray width measured in web travel direction L, and a unit or combination of a valve, a pulsation damper (and/or a flexible feed line) and a nozzle with a large spray width measured in the web travel direction can be used in accordance with the features of the present invention. With both units or combinations, an anchor valve, e.g., a plate anchor valve, or a needle valve can be used as the valve. Both units or combinations can be used, e.g., for spraying moving fibrous material webs, in particular in sprayers in paper and cardboard machines, such as in nozzle moisteners, coating aggregates, starch sprayers, profiling installations and/or the like. With both units or combinations, e.g., an elliptical flat spray nozzle or a full cone nozzle can be provided as a nozzle with large spray width b, measured in the web travel direction.

With a unit or combination of a valve, a pulsation damper (and/or a flexible feed line) and a nozzle with large spray width b, measured in the web travel direction, fluctuations in the moisture are largely eliminated by spraying on the moving web, so that such units can also be used, e.g., with fast moving webs.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

10 Sprayer

12 Fibrous material web

14 Nozzle

16 Spray medium

18 Pulsation damper

20 Valve

22 Line

24 Line

L Web travel direction

SR Spray direction

bₗ Spray width measured in the web travel direction

b_{q} Spray width measured in the web cross direction

α Pitch angle

What is claimed:

1. A process for spraying a moving fibrous material web with at least one nozzle, comprising:
feeding a spray medium volume flow of the at least one nozzle via at least one valve; and
damping or weakening pulsations occurring in the volume flow of the spray medium.

2. The process in accordance with claim 1, wherein the fibrous material web comprises one of a paper or cardboard web.

3. The process in accordance with claim 1, wherein the at least one nozzle feeds an adjustable volume flow of the spray medium.

4. The process in accordance with claim 3, wherein the at least one valve comprises one of a pulsation valve or a discontinuously activated proportional valve.

5. The process in accordance with claim 4, wherein the at least one valve comprises a solenoid valve.

6 The process in accordance with claim 4, wherein the pulse valve comprises one of an anchor valve or a plate anchor valve, and the proportional valve comprises a pulsation valve.

7. The process in accordance with claim 1, further comprising adjusting the spray medium volume flow fed to the at least one nozzle via the at least one valve.

8. The process in accordance with claim 1, wherein the damping or weakening of pulsations comprises at least one of:
(A) positioning at least one pulsation damper upstream of the at least one nozzle relative to a volume flow direction;
(B) spraying a large spray width measured in a web travel direction via the at least one nozzle; and
(C) feeding the spray medium to the at least one nozzle through a flexible feed line.

9. The process in accordance with claim 8, wherein the at least one nozzle has a large spray width measured in the web travel direction comprises with a spray width measured in the web travel direction which is at least about 30% of the spray width measured in the web cross direction.

10. The process in accordance with claim 9, wherein the spray width measured in the web travel direction which is at least about 50% of the spray width measured in the web cross direction.

11. The process in accordance with claim 1, wherein the at least one nozzle comprises an elliptical flat spray nozzle.

12. The process in accordance with claim 1, wherein the at least one nozzle comprises a flat spray nozzle arranged to spray the spray medium in a direction opposite a web travel direction, and at a pitch angle less than approx. 80°.

13. The process in accordance with claim 12, wherein the pitch angle is less than approx. 70°.

14. The process in accordance with claim 12, wherein the web is driven at a web speed greater than about 1200 m/min.

15. The process in accordance with claim 14, wherein the web speed is greater than about 1500 m/min.

16. The process in accordance with claim 1, wherein the at least one nozzle comprises a full cone nozzle.

17. The process in accordance with claim 1, wherein the spray medium volume flow fed through the nozzle is adjusted by a pulse width modulation.

18. The process in accordance with claim 17, wherein the at least one valve is activated with a constant clock frequency.

19. The process in accordance with claim 18, wherein the clock frequency is less than about 120 Hz.

20. The process in accordance with claim 19, wherein the clock frequency is less than about 70 Hz.

21. The process in accordance with claim 19, wherein the clock frequency is less than about 30 Hz.

22. The process in accordance with claim 1, wherein the web is being produced in one of a paper or a cardboard machine, and the process occurs in at least one of nozzle moisteners, coating aggregates, additive sprayers, and profiling installations of the paper or cardboard machine.

23. A device for spraying a moving fibrous material web, comprising:
at least one nozzle;
at least one valve arranged to feed a spray medium volume flow to said at least one nozzle; and
a damping element arranged to damp or weaken pulsations occurring in the volume flow of the spray medium.

24. The device in accordance with claim 23, wherein the fibrous material web comprises one of a paper and a cardboard web.

25. The device in accordance with claim 23, wherein said at least one valve is structured and arranged to adjust the volume flow of the spray medium to said at least one nozzle.

26. The device in accordance with claim 25, wherein said at least one valve comprises one of a pulsation valve or a discontinuously activated proportional valve.

27. The device in accordance with claim 26, wherein said at least one valve comprises a solenoid valve arranged to adjust the volume flow fed to said at least one nozzle.

28. The device in accordance with claim 26, wherein said pulsation valve comprises an anchor valve and said proportional valve comprises a needle valve.

29. The device in accordance with claim 28, wherein said anchor valve comprises a plate anchor valve.

30. The device in accordance with claim 23, wherein said damping element comprises at least one of:
(A) at least one pulsation damper located upstream of said at least one nozzle;
(B) said at least one nozzle, which is structured and arranged to produce a large spray width measured in a web travel direction; and
(C) a flexible feed line coupled to said nozzle.

31. The device in accordance with claim 30, wherein said at least one nozzle is structured and arranged to produce a spray width measured in the web travel direction that is at least about 30% of a spray width measured in the web cross direction.

32. The device in accordance with claim 31, wherein said at least one nozzle is structured and arranged to produce a spray width measured in the web travel direction that is at least about 50% of a spray width measured in the web cross direction.

33. The device in accordance with claim 23, wherein said at least one nozzle comprises an elliptical flat spray nozzle.

34. The device in accordance with claim 23, wherein said at least one nozzle comprises a flat spray nozzle.

35. The device in accordance with claim 34, wherein said flat spray nozzle is oriented in a direction opposite a web travel direction, and at a pitch angle of less than approx. 80°.

36. The device in accordance with claim 35, wherein the pitch angle is less than approx. 70°.

37. The device in accordance with claim 23, wherein said at least one nozzle comprises a full cone nozzle.

38. The device in accordance with claim 23, wherein said at least one valve adjusts the volume flow by a pulse width modulation.

39. The device in accordance with claim 38, wherein said at least one valve is activated with a constant clock frequency.

40. The device in accordance with claim 39, wherein the clock frequency is less than about 90 Hz.

41. The device in accordance with claim 40, wherein the clock frequency is less than about 30 Hz.

42. The device in accordance with claim 40, wherein the clock frequency is less than about 10 Hz.

43. The device in accordance with claim 23, wherein said damping element comprises a flexible feed line composed of a polyethylene, polyurethane or polyamide hose.

44. The device in accordance with claim 43, wherein said flexible feed line to said at least one nozzle has a length longer than about 3 m.

45. The device in accordance with claim 44, wherein the length of said flexible feed line is longer than about 5 m.

46. The device in accordance with claim 23, wherein said at least one valve and said damping element are arranged in a unit.

47. The device in accordance with claim 23, wherein said at least one valve, said damping element comprising at least one of a pulsation damper and a flexible feed line, and said at least one nozzle are arranged in a unit.

48. The device in accordance with claim 23 in combination with one of a paper or a cardboard machine, wherein said device is arranged in at least one of nozzle moisteners, coating aggregates, starch sprayers, and profiling installations of said one paper or cardboard machine.

49. A process for spraying a moving fibrous material web with the device recited in claim 23, said process comprising:
feeding an adjustable spray medium volume flow of the at least one nozzle via the at least one valve, which comprises one of a pulsation valve or a discontinuously activated proportional valve; and
damping or weakening pulsations occurring in the volume flow of the spray medium.

50. A device for performing the process in accordance with claim 1, said device comprising:
at least one nozzle;
at least one valve structured and arranged to adjust a volume flow of a spray medium to said at least one nozzle in order to feed the spray medium volume flow to said at least one nozzle, wherein said at least one valve comprises one of a pulsation valve or a discontinuously activated proportional valve; and
a damping element arranged to damp or weaken pulsations occurring in the volume flow of the spray medium.
